(19) United States
(12) Patent Application Publication
(10) Pub. No.: US 2026/0180394 A1
(43) Pub. Date: Jun. 25, 2026

(54) Radial-Axial One-Piece Magnetic Bearing for an Energy Storage Device

(71) Applicant: Huachi Kinetic Energy (Beijing) Technology Co., Ltd, Beijing (CN)

(72) Inventors: Zhiqiang Wang, Beijing (CN); Sen Su, Beijing (CN)

(21) Appl. No.: 18/728,955

(22) PCT Filed: Jan. 17, 2023
(86) PCT No.: PCT/CN2023/072603

§ 371 Date: Jul. 15, 2024

(30) Foreign Application Priority Data
Jan. 18, 2022 (CN) 202210056390.9

(51) Int. Cl. H02K 7/09; F16C 32/04; H02K 1/14; H02K 1/28

(52) U.S. Cl. CPC H02K 7/09; F16C 32/0442; F16C 32/048; H02K 1/148; H02K 1/28

(57) ABSTRACT

A radial-axial integrated magnetic bearing for an energy storage device, includes a bearing rotor and a bearing stator. Further disclosed is an energy storage device including the radial-axial integrated magnetic bearing.

### CROSS-REFERENCE TO RELATED APPLICATIONS

This application is a U.S. national phase application of International Application No. PCT/CN2023/072603, filed on Jan. 17, 2023, which is based on and claims priority to the Chinese Patent Application No. 202210056390.9, filed on Jan. 18, 2022, the entire content of which is incorporated herein by reference.

### FIELD

The present disclosure relates to the technical field of bearing, specifically to a radial-axial one-piece magnetic bearing for an energy storage device and an energy storage device.

### BACKGROUND

Magnetic bearing is a new type of high-performance bearing. There is no mechanical contact in magnetic bearings and a rotor can reach a very high running speed, with the advantages of low mechanical wear, low energy consumption, low noise, long service life, no lubrication, no oil pollution and the like, especially suitable for high-speed, vacuum, ultra-clean and other special environments. It can be widely used in the fields of machining, turbomachinery, aerospace, vacuum technology, rotor dynamics identification and testing, etc., and is recognized as a promising new type of bearing. The magnetic bearing in the related technology is of a single function and unreasonable structure. When applied in an energy storage device, a large number of the magnetic bearings are required, with a large installation space occupied, the high cost and complexity to disassemble with the energy storage device.

### SUMMARY

The present disclosure aims to solve at least one of the technical problems in the related art to a certain extent.

In view of the above, the present disclosure provides in embodiments a radial-axial one-piece magnetic bearing for an energy storage device, which are both functional as a radial magnetic bearing and an axial magnetic bearing meanwhile, thus reducing the number of the magnetic bearings in an energy storage device, lowering the cost, making it convenient to disassembly and assembly and saving the installation space.

The present disclosure further provides in embodiments an energy storage device.

According to embodiments of the present disclosure, a radial-axial one-piece magnetic bearing for an energy storage device including: a bearing rotor, with an axis extended in an up-down direction and provided, at a lower end of the bearing rotor, with an annular rotor magnetic steel extended along a circumferential direction of the bearing rotor; and a bearing stator, arranged below the bearing rotor and formed with a recess at an upper end face of the bearing stator, where the lower end of the bearing rotor is fit in the recess, an annular stator magnetic steel extended along the circumferential direction of the bearing stator is positioned at a wall of the recess, at least part of the annular stator magnetic steel is opposite to the annular rotor magnetic steel in the up-down direction and positioned below the annular rotor magnetic steel, and at least part of the annular stator magnetic steel is opposite to the annular rotor magnetic steel in a radial direction of the bearing rotor, where the annular rotor magnetic steel repels the annular stator magnetic steel.

According to the radial-axial one-piece magnetic bearing for an energy storage device in embodiments of the present disclosure, the bearing rotor is provided with the annular rotor magnetic steel and the bearing stator is provided with the annular stator magnetic steel, and at least part of the annular stator magnetic steel is opposite to the annular rotor magnetic steel in the up-down direction and at least part of the annular stator magnetic steel is opposite to the annular rotor magnetic steel in a radial direction of the bearing rotor, thus the annular rotor magnetic steel and the annular stator magnetic steel can provide a magnetic repulsive force in the up-down direction for not only balancing gravities of rotors of the energy storage device and the bearing rotor in the up-down direction, but also in the radial direction for relatively balancing the bearing rotor, thereby achieving the aim of replacing both of a radial magnetic bearing and an axial magnetic bearing by a single radial-axial one-piece magnetic bearing for an energy storage device in embodiments of the present disclosure. That is, the radial-axial one-piece magnetic bearing for an energy storage device provided in embodiments of the present disclosure has multiple functions and can reduce the number of the magnetic bearings in an energy storage device, lower the cost, make it convenient to disassembly and assembly and save the installation space. In addition, the magnetic steels used in embodiments of the present disclosure possess magnetic forces, which are free of control systems in relative to an electromagnet, thereby reducing the cost further.

In some embodiments, the annular rotor magnetic steel and the annular stator magnetic steel provide a magnetic repulsive force both in the up-down direction for balancing gravities of a rotor of the energy storage device and the bearing rotor and in the radial direction for relatively balancing the bearing rotor.

In some embodiments, the annular rotor magnetic steel tilts and extends inwardly from top to bottom, and the annular stator magnetic steel tilts and extends inwardly from top to bottom, and the annular rotor magnetic steel is arranged above the annular stator magnetic steel.

In some embodiments, the magnetic repulsive force is generated between the annular rotor magnetic steel and the annular stator magnetic steel is towards an oblique upward direction, with a vertical component to balance gravity and a horizontal component to balance the bearing rotor in the radial direction.

In some embodiments, the bearing rotor is formed, at the lower end, with a tapered segment fit in the recess, an outer peripheral face of the tapered segment tilts and extends inwardly from top to bottom, a peripheral face of the recess tilts and extends inwardly from top to bottom, the outer peripheral face of the tapered segment is opposite to and spaced apart from the peripheral face of the recess in a first direction perpendicular to the outer peripheral face of the tapered segment, and the annular rotor magnetic steel is positioned at the outer peripheral face of the tapered segment, and the annular stator magnetic steel is positioned at the peripheral face of the recess.

In some embodiments, the annular rotor magnetic steel is directly opposite to the annular stator magnetic steel in the first direction.

In some embodiments, a first annular fitting slot extended along a circumferential direction of the outer peripheral face of the tapered segment is provided at the outer peripheral face of the tapered segment, the annular rotor magnetic steel is fit in the first annular fitting slot; and a second annular fitting slot extended along a circumferential direction of the peripheral face of the recess is provided at the peripheral face of the recess, the annular stator magnetic steel is fit in the second annular fitting slot.

In some embodiments, the radial-axial one-piece magnetic bearing for an energy storage device further includes: a rotor magnetic steel sleeve, extended along the circumferential direction of the bearing rotor and fit in the first annular fitting slot, wherein the annular rotor magnetic steel is fit in the rotor magnetic steel sleeve; and a stator magnetic steel sleeve, extended along the circumferential direction of the bearing stator and fit in the second annular fitting slot.

In some embodiments, the radial-axial one-piece magnetic bearing for an energy storage device further includes: a rotor pressing ring, detachably connected to the tapered segment and abutted against the rotor magnetic steel sleeve so as to press the rotor magnetic steel sleeve tightly; and a stator pressing ring, detachably connected to the bearing stator and abutted against the stator magnetic steel sleeve so as to press the stator magnetic steel sleeve tightly.

In some embodiments, the rotor pressing ring is positioned at the bottom of the tapered segment, and the stator pressing ring is positioned at the top of the bearing stator.

In some embodiments, the first annular fitting slot is formed at the bottom of the tapered segment and opens towards the bearing stator; the second annular fitting slot is formed at the top of the bearing stator and opens towards the bearing rotor; the stator pressing ring positioned at the top of the bearing stator is for pressing an upper end of the stator magnetic steel sleeve so as to press the stator magnetic steel sleeve into the second annular fitting slot tightly; and the rotor pressing ring positioned at the bottom of the tapered segment is for pressing a lower end of the rotor magnetic steel sleeve so as to press the rotor magnetic steel sleeve into the first annular fitting slot tightly.

In some embodiments, the radial-axial one-piece magnetic bearing for an energy storage device further includes a protective bearing, where the bottom face of the recess is provided with a lug boss protruding towards the tapered segment, an upper end of the lug boss is fit in a ring hole of the rotor pressing ring, the protective bearing is fit over the upper end of the lug boss, and the protective bearing is spaced apart from the rotor pressing ring in the radial direction of the bearing rotor.

An energy storage device in embodiments of the present disclosure includes a radial-axial one-piece magnetic bearing for an energy storage device according to any one of embodiments as described above.

The energy storage device in embodiments of the present disclosure is of a simple structure and low cost by utilizing the radial-axial one-piece magnetic bearing for an energy storage device as described above.

### BRIEF DESCRIPTION OF THE DRAWINGS

FIG. 1 is a structure diagram showing a radial-axial one-piece magnetic bearing for an energy storage device according to Examples of the present disclosure.

References in the drawings include:

bearing rotor 1; tapered segment 11; bearing stator 2; recess 21; annular rotor magnetic steel 3; rotor magnetic steel sleeve 4; rotor pressing ring 5; annular stator magnetic steel 6; stator magnetic steel sleeve 7; stator pressing ring 8; lug boss 9; and protective bearing 10.

### DETAILED DESCRIPTION

Reference will be made in detail to embodiments of the present disclosure, and examples of the embodiments are shown in the drawings. The embodiments described herein with reference to drawings are explanatory, illustrative, and used to generally understand the present disclosure. The embodiments shall not be construed to limit the present disclosure.

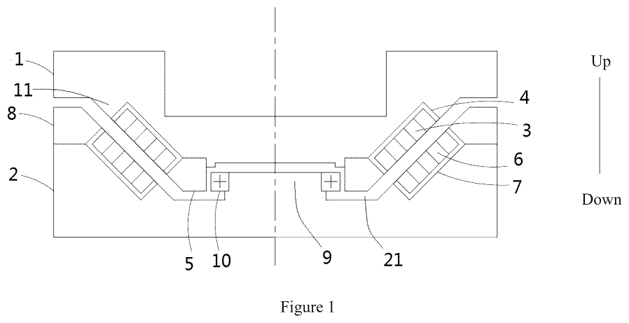

As shown in FIG. 1, a radial-axial one-piece magnetic bearing for an energy storage device in Examples includes a bearing rotor 1 and a bearing stator 2. It should be noted that the radial-axial one-piece magnetic bearing for an energy storage device in Examples of the present disclosure may be used in devices requiring shaft drive such as an energy storage device, a drive device and the like, and is used for supporting a rotor arranged vertically, where the bearing rotor 1 is suitable for connecting to a rotor of the energy storage device, while the bearing stator 2 is suitable for connecting to a stator of the energy storage device.

As shown in FIG. 1, an axis of the bearing rotor 1 is extended in an up-down direction, and an annular rotor magnetic steel 3 extended along a circumferential direction of the bearing rotor is provided at a lower end of the bearing rotor 1. The bearing stator 2 is arranged below the bearing rotor 1 and is formed with a recess 21 the lower end of the bearing rotor 1 fit in. An annular stator magnetic steel 6 extended along the circumferential direction of the bearing stator 2 is positioned at an inner wall of the recess 21. At least part of the annular stator magnetic steel 6 is opposite to the annular rotor magnetic steel 3 in the up-down direction and positioned below the annular rotor magnetic steel 3, and at least part of the annular stator magnetic steel is opposite to the annular rotor magnetic steel 3 in a radial direction of the bearing rotor 1, where the annular rotor magnetic steel 3 repels the annular stator magnetic steel 6.

It could be understood that the bearing rotor 1 possesses its gravity when arranged vertically, and the part the annular stator magnetic steel 6 opposite to the annular rotor magnetic steel 3 in the up-down direction repels the annular rotor magnetic steel 3 to balance gravities of the bearing rotor 1 and the rotors of the energy storage device, thus balancing the rotors of the energy storage device in its axial direction, that is, the radial-axial one-piece magnetic bearing for an energy storage device in Examples of the present disclosure presents the function of an axial magnetic bearing.

Further, the part the annular stator magnetic steel 6 opposite to the annular rotor magnetic steel 3 in a radial direction of the bearing rotor 1 repels the annular rotor magnetic steel 3 to form a relatively balanced force in the circumferential direction of the bearing rotor 1, to support the rotors of the energy storage device. It could be understood that when the rotor of the energy storage device tends to deflect, the deflecting rotor of the energy storage device would drive the bearing rotor deflecting, with an increasing repulsion between the deflecting annular rotor magnetic steel 3 and the annular stator magnetic steel 6, thus preventing the rotor of the energy storage device from deflecting, that is, the radial-axial one-piece magnetic bearing for an energy storage device in Examples of the present disclosure presents the function of a radial magnetic bearing meanwhile.

In the related art, magnetic bearings generally used includes radial magnetic bearings and axial magnetic bearings, which are arranged individually when applied in a device to realize a support and balance to the rotors in their radial and axial directions respectively. However, the above manner requires a large number of magnetic bearings, with the problems of a large installation space occupied, the high cost and complexity to be installed.

In Examples of the present disclosure, the bearing rotor 1 is provided with the annular rotor magnetic steel 3 and the bearing stator 2 is provided with the annular stator magnetic steel 6, and there is a magnetic repulsive force, between the annular rotor magnetic steel 3 and the annular stator magnetic steel 6, not only existing in the up-down direction, but also in the radial direction. That is, the radial-axial one-piece magnetic bearing in Examples of the present disclosure has both functions of a radial magnetic bearing and an axial magnetic bearing at the same time, thereby reducing the number of magnetic bearings to be used in an energy storage device for practical applications. In other words, the radial-axial one-piece magnetic bearing in Examples of the present disclosure can replace both of a radial magnetic bearing and an axial magnetic bearing.

According to the radial-axial one-piece magnetic bearing for an energy storage device in Examples of the present disclosure, the bearing rotor is provided with the annular rotor magnetic steel and the bearing stator is provided with the annular stator magnetic steel, and at least part of the annular stator magnetic steel is opposite to the annular rotor magnetic steel in the up-down direction and at least part of the annular stator magnetic steel is opposite to the annular rotor magnetic steel in a radial direction of the bearing rotor, thus the annular rotor magnetic steel and the annular stator magnetic steel can provide a magnetic repulsive force not only balancing gravities of rotors of the energy storage device and the bearing rotor in the up-down direction, but also relatively balancing the bearing rotor in the radial direction, thereby achieving the aim of replacing both of a radial magnetic bearing and an axial magnetic bearing by a single radial-axial one-piece magnetic bearing for an energy storage device in Examples of the present disclosure. That is, the radial-axial one-piece magnetic bearing for an energy storage device provided in Examples of the present disclosure has multiple functions and can reduce the number of the magnetic bearings in an energy storage device, lower the cost, make it convenient to disassembly and assembly and save the installation space. In addition, the magnetic steels used in Examples of the present disclosure possess magnetic forces, which are free of control systems in relative to an electromagnet, thereby reducing the cost further.

In some Examples, as shown in FIG. 1, the annular rotor magnetic steel 3 tilts and extends inwardly from top to bottom, and the annular stator magnetic steel 6 tilts and extends inwardly from top to bottom, and the annular rotor magnetic steel 3 is arranged above the annular stator magnetic steel 6. Accordingly, the magnetic repulsive force generated between the annular rotor magnetic steel 3 and the annular stator magnetic steel 6 directs towards an oblique upward direction, and possesses a vertical component to balance gravity and a horizontal component to form a balance in the radial direction of the rotor.

Further, as shown in FIG. 1, the bearing rotor is formed, at the lower end, with a tapered segment 11 fit in the recess 21, an outer peripheral face of the tapered segment 11 tilts and extends inwardly from top to bottom, a peripheral face of the recess 21 tilts and extends inwardly from top to bottom, the outer peripheral face of the tapered segment 11 is opposite to and spaced apart from the peripheral face of the recess 21 in a first direction perpendicular to the outer peripheral face of the tapered segment 11, and the annular rotor magnetic steel 3 is positioned at the outer peripheral face of the tapered segment 11 and the annular stator magnetic steel 6 is positioned at the peripheral face of the recess 21.

In other words, the outer peripheral face of the tapered segment 11 and the peripheral face of the slot 21 are inclined planes opposite to each other, thus facilitating a stable assembly of the annular rotor magnetic steel 3 and the annular stator magnetic steel 6 arranged obliquely.

In some Examples, as shown in FIG. 1, the annular rotor magnetic steel 3 is directly opposite to the annular stator magnetic steel 6 in the first direction.

Further, as shown in FIG. 1, a first annular fitting slot extended along a circumferential direction of the outer peripheral face of the tapered segment 11 is provided at the outer peripheral face of the tapered segment 11, the annular rotor magnetic steel 3 is fit in the first annular fitting slot; and a second annular fitting slot extended along a circumferential direction of the peripheral face of the recess 21 is provided at the peripheral face of the recess 21, the annular stator magnetic steel 6 is fit in the second annular fitting slot.

Further, as shown in FIG. 1, the radial-axial one-piece magnetic bearing for an energy storage device further includes: a rotor magnetic steel sleeve 4, extended along the circumferential direction of the bearing rotor 1 and fit in the first annular fitting slot, where the annular rotor magnetic steel 3 is fit in the rotor magnetic steel sleeve 4; and a stator magnetic steel sleeve 7, extended along the circumferential direction of the bearing rotor 1 and fit in the second annular fitting slot. Accordingly, the stator magnetic steel sleeve 7 and the rotor magnetic steel sleeve 4 conveniently accommodate the annular stator magnetic steel 6 and the annular rotor magnetic steel 3 respectively, to facilitate the overall disassembly of the magnetic steels; and the fitting slots for accommodating the magnetic steel sleeves facilitate the precise assembly of the magnetic steel sleeves without the need for complex connections thus having a simple structure.

Further, as shown in FIG. 1, the radial-axial one-piece magnetic bearing for an energy storage device further includes: a rotor pressing ring 5, detachably connected to the tapered segment 11 and abutted against the rotor magnetic steel sleeve 4 so as to press the rotor magnetic steel sleeve 4 tightly; and a stator pressing ring 8, detachably connected to the bearing stator 2 and abutted against the stator magnetic steel sleeve 7 so as to press the stator magnetic steel sleeve 7 tightly.

Further, the rotor pressing ring 5 is positioned at the bottom of the tapered segment 11, and the stator pressing ring 8 is positioned at the top of the bearing stator 2. As shown in FIG. 1, the first annular fitting slot is formed at the bottom of the tapered segment 11 and open towards the bearing stator 2, the second annular fitting slot is formed at the top of the bearing stator 2 and opens towards the bearing rotor 1, the stator pressing ring 8 positioned at the top of the bearing stator 2 can press an upper end of the stator magnetic steel sleeve 7 so as to compress the stator magnetic steel sleeve 7 into the second annular fitting slot tightly; and the rotor pressing ring 5 positioned at the bottom of the tapered segment 11 can press a lower end of the rotor magnetic steel sleeve 4 so as to compress the rotor magnetic steel sleeve 4 into the first annular fitting slot tightly. Thus, the stator pressing ring 8 can prevent the annular stator magnetic steel 6 from shaking and the rotor pressing ring 5 can prevent the annular rotor magnetic steel 3 from shaking.

Further, as shown in FIG. 1, the radial-axial one-piece magnetic bearing for an energy storage device further includes: a protective bearing 10, where the bottom face of the recess 21 is provided with a lug boss 9 protruding towards the tapered segment 11, an upper end of the lug boss 9 is fit in a ring hole of the rotor pressing ring 5, and the protective bearing 10 is fit over the upper end of the lug boss 9, and the protective bearing 10 is spaced apart from the rotor pressing ring 5 in the radial direction of the bearing rotor 1. Accordingly, the protective bearing 10 may serve as a mechanical bearing to keep the rotor rotating when the annular rotor magnetic steel 3 and the annular stator magnetic steel 6 fail, and the lug boss 9 may serve as a supporting roller for the protective bearing 10 in which the protective bearing 10 is rotatable relative to the lug boss 9. Specifically, when the bearing rotor 1 is deflected in the radial direction, the protective bearing 10 can abut against the rotor pressing ring 5 which drives the protective bearing 10 to rotate around the lug boss 9.

An energy storage device in Examples of the present disclosure includes a radial-axial one-piece magnetic bearing for an energy storage device according to any one of Examples as described above.

The energy storage device in Examples of the present disclosure is of a simple structure and low cost by utilizing the radial-axial one-piece magnetic bearing for an energy storage device as described above.

In the specification, it should be understood that, the terms indicating orientation or position relationship such as “central”, “longitudinal”, “lateral”, “width”, “thickness”, “above”, “below”, “front”, “rear”, “right”, “left”, “vertical”, “horizontal”, “top”, “bottom”, “inner”, “outer”, “clockwise”, “counter-clockwise”, “axial”, “radial”, “circumferential” or the like should be construed to refer to the orientation or position relationship as described or as shown in the drawings. These terms are merely for convenience and concision of description and do not alone indicate or imply that the device or element referred to must have a particular orientation or must be configured or operated in a particular orientation. Thus, it cannot be understood to limit the present disclosure.

In addition, terms such as “first” and “second” are used herein for purposes of description and are not intended to indicate or imply relative importance or impliedly indicate quantity of the technical feature referred to. Thus, the feature defined with “first” and “second” may indicate or imply that at least one of these features. In the description of the present disclosure, “a plurality of” means two or more than two this features, such as two, three and the like, unless specified otherwise.

In the present disclosure, unless specified or limited otherwise, the terms “mounted”, “connected”, “coupled”, “fixed” and the like are used broadly, and may be, for example, a fixed connection, a detachable connection, or an integrated connection; may be a mechanical connection, may also by an electrical connections or communicate with each other; may also be a direct connection or an indirect connection via an intervening structure; may also be an inner communication of two elements or a mutual interaction between two elements, which can be understood by those skilled in the art according to specific situations.

In the present disclosure, unless specified or limited otherwise, a structure in which a first feature is “on” or “below” a second feature may be an embodiment in which the first feature is in direct contact with the second feature, or an embodiment in which the first feature and the second feature are contacted indirectly via an intermediation. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Reference throughout this specification to “an embodiment”, “some embodiments”, “one embodiment”, “another example”, “an example”, “a specific example” or “some examples” means that a particular feature, structure, material, or characteristic described in connection with the embodiment or example is included in at least one embodiment or example of the present disclosure. Thus, the appearances of the phrases such as “in some embodiments”, “in one embodiment”, “in an embodiment”, “in another example”, “in an example”, “in a specific example” or “in some examples”, in various places throughout this specification are not necessarily referring to the same embodiment or example of the present disclosure. Furthermore, the particular features, structures, materials, or characteristics may be combined in any suitable manner in one or more embodiments or examples. In addition, different embodiments or examples and features in different embodiments or examples as described in this specification may be combined by those skilled in the art, without conflicting with each other.

Although explanatory embodiments have been shown and described, it would be appreciated by those skilled in the art that the above embodiments cannot be construed to limit the present disclosure, and changes, alternatives, and modifications can be made in the embodiments in the scope of the present disclosure.

1. A radial-axial one-piece magnetic bearing for an energy storage device, comprising:
a bearing rotor, with an axis extended in an up-down direction and provided, at a lower end of the bearing rotor, with an annular rotor magnetic steel extended along a circumferential direction of the bearing rotor; and
a bearing stator, arranged below the bearing rotor and formed with a recess at an upper end face of the bearing stator, wherein the lower end of the bearing rotor is fit in the recess, an annular stator magnetic steel extended along the circumferential direction of the bearing stator is positioned at a wall of the recess, at least part of the annular stator magnetic steel is opposite to the annular rotor magnetic steel in the up-down direction and positioned below the annular rotor magnetic steel, and at least part of the annular stator magnetic steel is opposite to the annular rotor magnetic steel in a radial direction of the bearing rotor, wherein the annular rotor magnetic steel repels the annular stator magnetic steel.

2. The magnetic bearing according to claim 1, wherein the annular rotor magnetic steel and the annular stator magnetic steel provide a magnetic repulsive force both in the up-down direction for balancing gravities of a rotor of the energy storage device and the bearing rotor and in the radial direction for relatively balancing the bearing rotor.

3. The magnetic bearing according to claim 1, wherein
the annular rotor magnetic steel tilts and extends inwardly from top to bottom,
the annular stator magnetic steel tilts and extends inwardly from top to bottom, and
the annular rotor magnetic steel is arranged above the annular stator magnetic steel.

4. The magnetic bearing according to claim 3, wherein
a magnetic repulsive force is generated between the annular rotor magnetic steel and the annular stator magnetic steel towards an oblique upward direction, and
the magnetic repulsive force has a vertical component to balance gravity and a horizontal component to balance the bearing rotor in the radial direction.

5. The magnetic bearing according to claim 3, wherein
the bearing rotor is formed, at the lower end, with a tapered segment fit in the recess,
an outer peripheral face of the tapered segment tilts and extends inwardly from top to bottom,
a peripheral face of the recess tilts and extends inwardly from top to bottom,
the outer peripheral face of the tapered segment is opposite to and spaced apart from the peripheral face of the recess in a first direction perpendicular to the outer peripheral face of the tapered segment, and
the annular rotor magnetic steel is positioned at the outer peripheral face of the tapered segment, and
the annular stator magnetic steel is positioned at the peripheral face of the recess.

6. The magnetic bearing according to claim 5, wherein the annular rotor magnetic steel is directly opposite to the annular stator magnetic steel in the first direction.

7. The magnetic bearing according to claim 5, wherein
a first annular fitting slot extended along a circumferential direction of the outer peripheral face of the tapered segment is provided at the outer peripheral face of the tapered segment, the annular rotor magnetic steel is fit in the first annular fitting slot; and
a second annular fitting slot extended along a circumferential direction of the peripheral face of the recess is provided at the peripheral face of the recess, the annular stator magnetic steel is fit in the second annular fitting slot.

8. The magnetic bearing according to claim 7, further comprising:
a rotor magnetic steel sleeve, extended along the circumferential direction of the bearing rotor and fit in the first annular fitting slot, wherein the annular rotor magnetic steel is fit in the rotor magnetic steel sleeve; and
a stator magnetic steel sleeve, extended along the circumferential direction of the bearing stator and fit in the second annular fitting slot, wherein the annular stator magnetic steel is fit in the stator magnetic steel sleeve.

9. The magnetic bearing according to claim 8, further comprising:
a rotor pressing ring, detachably connected to the tapered segment and abutted against the rotor magnetic steel sleeve so as to press the rotor magnetic steel sleeve tightly; and
a stator pressing ring, detachably connected to the bearing stator and abutted against the stator magnetic steel sleeve so as to press the stator magnetic steel sleeve tightly.

10. The magnetic bearing according to claim 9, wherein
the rotor pressing ring is positioned at the bottom of the tapered segment, and
the stator pressing ring is positioned at the top of the bearing stator.

11. The magnetic bearing according to claim 9, wherein
the first annular fitting slot is formed at the bottom of the tapered segment and opens towards the bearing stator;
the second annular fitting slot is formed at the top of the bearing stator and opens towards the bearing rotor;
the stator pressing ring positioned at the top of the bearing stator is for pressing an upper end of the stator magnetic steel sleeve so as to press the stator magnetic steel sleeve into the second annular fitting slot tightly; and
the rotor pressing ring positioned at the bottom of the tapered segment is for pressing a lower end of the rotor magnetic steel sleeve so as to press the rotor magnetic steel sleeve into the first annular fitting slot tightly.

12. The magnetic bearing according to claim 11, further comprising a protective bearing, wherein
the bottom face of the recess is provided with a lug boss protruding towards the tapered segment,
an upper end of the lug boss is fit in a ring hole of the rotor pressing ring,
the protective bearing is fit over the upper end of the lug boss, and
the protective bearing is spaced apart from the rotor pressing ring in the radial direction of the bearing rotor.

13. An energy storage device, comprising a radial-axial one-piece magnetic bearing for an energy storage device according to claim 1.
